(19) United States
(12) Patent Application Publication
(10) Pub. No.: US 2026/0025062 A1
(43) Pub. Date: Jan. 22, 2026

(54) SINGLE INDUCTOR MULTIPLE OUTPUT CONVERTER WITH RINGING

(71) Applicant: Advanced Analog Technology, Inc., ZHUBEI CITY (TW)

(72) Inventors: Chih-Chiang WU, Zhubei City (TW); Chih-Liang HUANG, Zhubei City (TW); Yi-Hua LI, Zhubei City (TW); Chien-Jung LIAO, Zhubei City (TW); Teng-Liang YOU, Zhubei City (TW)

(21) Appl. No.: 18/907,916

(22) Filed: Oct. 7, 2024

(30) Foreign Application Priority Data
Jul. 18, 2024 (TW) 113126945

(51) Int. Cl. H02M 1/32; H02M 1/00; H02M 3/158

(52) U.S. Cl. CPC H02M 1/32; H02M 1/0025; H02M 3/158

(57) ABSTRACT

A single inductor multiple output converter with ringing elimination switch is used to convert a single input voltage into multiple output voltages, comprising a single-inductor conversion circuit, a ringing elimination switch, and a conversion control circuit. The single-inductor conversion circuit is electrically connected to the voltage input source and the voltage output source to convert the input voltage into output voltages and includes an inductor. The ringing elimination switch is electrically connected at a connecting terminal to the single-inductor conversion circuit and grounded at a grounding terminal. The conversion control circuit is electrically connected respectively to the single-inductor conversion circuit and the ringing elimination switch to send a switch-on control command to the ringing elimination switch during the interruption of the inductor's charging and discharging phases, thereby connecting the connecting terminal to the ground terminal to dissipate residual current in the inductor due to grounding, thereby eliminating ringing.

### CROSS-REFERENCE TO RELATED APPLICATIONS

This application claims the priority benefit of Taiwan application serial No. 113126945, filed on Jul. 18, 2024. The entirety of the above-mentioned patent application is hereby incorporated by reference herein and made a part of the specification.

### BACKGROUND OF THE INVENTION

### (1) Field of the Invention

The present invention relates to a single-inductor multiple output converter, and in particular to a single-inductor multiple output converter with a ringing elimination switch.

### (2) Description of the Prior Art

SIMO Converter (Single-Inductor Multiple Output Converter) can use only one inductor to convert a single input voltage into multiple different output voltages.

Compared with multi-inductor multiple output converters, single-inductor multiple output converters have the advantages of small size and relatively low cost. Therefore, single-inductor multiple output converters are mostly used in mobile devices, wearable devices or display devices.

The basic principle of a single-inductor multiple output converter is to control the switching of multiple switching elements to regulate the storage and release of electrical energy in the inductor, thereby controlling the output voltage. At the same time, the feedback control circuit monitors and controls the output voltage, and can accurately adjust the switching sequence of the switching elements to maintain the stability of the output voltage.

Refer to the FIG. 1, the FIG. 1 is a circuit diagram illustrating a single-inductor conversion circuit in the prior art. As shown in the first FIG. 1, in the prior art, a single-inductor multiple output converter PA100 is used to convert an input voltage Vin of a voltage input source PA200 into an output positive voltage Vop and an output negative voltage Von which are sent to a positive voltage output source PA300 and a negative voltage output source PA301, respectively. The single-inductor multiple output converter PA100 includes an inductor PL, a plurality of voltage stabilizing capacitors PAC1 to PAC3, and a plurality of inductor control switches PASW1 to PASW4. The inductor PL has a current input terminal PII and a current output terminal PIO. During operation, an inductor current IL flows from the current input terminal PII to the current output terminal PIO. The current input terminal PII and the current output terminal PIO respectively have an inductor input terminal voltage LXA and an inductor output terminal voltage LXB.

Refer to the FIGS. 2 and 3, the FIG. 2 shows the switch sequence diagram of a single-inductor multiple output converter in the prior art, and the FIG. 3 shows the voltage waveform of a single-inductor multiple output converter in the prior art. As shown in the FIG. 2, the inductor control switches PASW1 to PASW4 are periodically turned on or off in a voltage conversion sequence to charge and discharge the inductor PL, and convert the input voltage Vin into an output positive voltage Vop and an output negative voltage Von.

The voltage conversion sequence includes phases SP1 to SP4. In the phase SP1, the inductor control switch PASW1 and the inductor control switch PASW3 are turned on. In the phase SP2, the inductor control switch PASW1 and the inductor control switch PASW2 are turned on. In the phase SP3, the inductor control switch PASW3 and the inductor control switch PASW4 are turned on. In the phase SP4, the inductor control switch PASW3 is turned on. In the FIG. 2, the arrow indicates that the inductor control switch is turned on.

As shown in the FIG. 3, the single-inductor multiple output converter PA100 continuously converts the input voltage Vin into an output positive voltage Vop and an output negative voltage Von. Since the output positive voltage Vop and the output negative voltage Von continuously change during output, and are both saw-tooth wave voltages, in the FIG. 3, the solid line represents the actual voltage value, and the dotted line represents the average voltage value.

However, in phase SP4, the current input terminal PII is affected by the inductor PL and causes high-frequency ringing. The voltage LXA of the inductor input terminal of the current input terminal PII fluctuates greatly in phase SP4, which in turn causes EMI (ElectroMagnetic Interference) to electronic devices, leading to common problems such as signal distortion and reduced stability.

However, in phase SP4, the current input terminal PII is affected by the inductor PL and causes high-frequency ringing. The voltage LXA of the inductor input terminal of the current input terminal PII fluctuates greatly in phase SP4, which in turn causes EMI (ElectroMagnetic Interference) to electronic devices, leading to common problems such as signal distortion and reduced stability.

### SUMMARY OF THE INVENTION

In view of the fact that in the prior art, there are common problems such as signal distortion and reduced stability due to high-frequency ringing. Therefore, the main purpose of this invention is to provide a single-inductor multiple output converter with a ringing elimination switch, by turning on the ringing elimination switch when the inductor interrupts the charging and discharging phases, to make the residual current of the inductor dissipate due to grounding, thereby eliminating ringing and solving the above said problems.

Accordingly, the necessary technical means adopted by the present invention to solve the problems of the prior art is to provide a single-inductor multiple output converter with a ringing elimination switch (hereinafter referred to as the “single-inductor multiple output converter”), and it is used to convert an input voltage of a voltage input source into a plurality of output voltages and then output them to a plurality of voltage output sources respectively. The single-inductor multiple output converter includes a single-inductor conversion circuit, a ringing elimination switch, and a conversion control circuit.

The single-inductor conversion circuit is electrically connected to the voltage input source and the voltage output source respectively to convert the input voltage into the output voltage, and includes an inductor. Preferably, the single-inductor conversion circuit can include a plurality of inductor control switches, which are controlled to be turned on or off to repeatedly charge and discharge the inductor, thereby converting the input voltage into an output voltage. The ringing elimination switch is electrically connected to a single-inductor conversion circuit at a connecting end, and is grounded at a grounding end.

The conversion control circuit is electrically connected to the single-inductor conversion circuit and the ringing elimination switch respectively, and is used to periodically send a voltage control command to the single-inductor conversion circuit according to a voltage conversion sequence, and is used to send a switch turn-on control command to the ringing elimination switch to connect the connection terminal and the ground terminal when one of the inductors in the voltage conversion sequence interrupts the charging and discharging phases, so that the residual current of the inductor is dissipated due to grounding, thereby eliminating ringing. Preferably, the voltage control command includes a plurality of voltage control sub-commands arranged according to the voltage conversion sequence.

Based on the above said necessary technical means, the following subsidiary technical means can be derived to reduce the ripples generated during operation. Preferably, the single-inductor multiple output converter may also include a plurality of voltage regulators and a plurality of loads electrically connected to the above said voltage regulators, and the above said voltage regulators are electrically connected to the above said voltage output sources respectively. Preferably, the above said voltage regulators are all LDO (Low-Dropout Regulator).

Based on the above necessary technical means, the following subsidiary technical means can be derived to filter, eliminate high-frequency noise or stored energy. Preferably, the single-inductor multiple output converter may include multiple voltage stabilizing capacitors.

Based on the above necessary technical means, the following subsidiary technical means can be derived. Preferably, the single-inductor multiple output converter may further include a feedback control circuit, which is electrically connected to the single-inductor conversion circuit, the conversion control circuit and the voltage output source respectively, for sending a feedback control signal to the conversion control circuit.

As mentioned in the above, preferably, the conversion control circuit may include a switch logic control circuit and a switch drive circuit. The switch logic control circuit is electrically connected to the feedback control circuit, and is used to generate switch-on control commands and voltage control commands based on the feedback control signal. The switch driving circuit is electrically connected to the switch logic control circuit, the ringing elimination switch and the inductor control switches respectively, and is used to drive the ringing elimination switch to turn off or on according to the switch-on control command, and is used to drive some inductor control switches to cut off or turn on according to the voltage control command.

As said in the above, since in the single-inductor multiple output converter provided by the present invention, the ringing elimination switch is turned on when the inductor interrupts the charging and discharging phases, so that the residual current of the inductor dissipates due to grounding, thereby eliminating the ringing to solve the above said problems.

The specific embodiments used in the present invention will be further explained through the following embodiments and drawings.

### BRIEF DESCRIPTION OF THE DRAWINGS

The present invention will now be specified with reference to its preferred embodiment illustrated in the drawings, in which:

FIG. 1 is a circuit diagram illustrating a single-inductor multiple output conversion circuit in the prior art;

FIG. 2 shows the switch sequence diagram of a single-inductor multiple output converter in the prior art;

FIG. 3 shows the voltage waveform of a single-inductor multiple output converter in the prior art;

FIG. 4 illustrates a system block diagram of the single-inductor multiple output converter provided by the present invention;

FIG. 5 is a circuit diagram illustrating the single-inductor conversion circuit of the single-inductor multiple output converter provided by the present invention;

FIG. 6A and FIG. 6B are circuit diagrams illustrating the conversion control circuit of the single-inductor multiple output converter provided by the present invention;

FIG. 7 illustrates the switching sequence diagram of the single-inductor multiple output converter provided by the present invention;

FIG. 8 illustrates the inductor current and slope voltage waveforms of the single-inductor multiple output converter provided by the present invention; and

FIG. 9 illustrates the voltage waveform diagram of the single-inductor multiple output converter provided by the present invention.

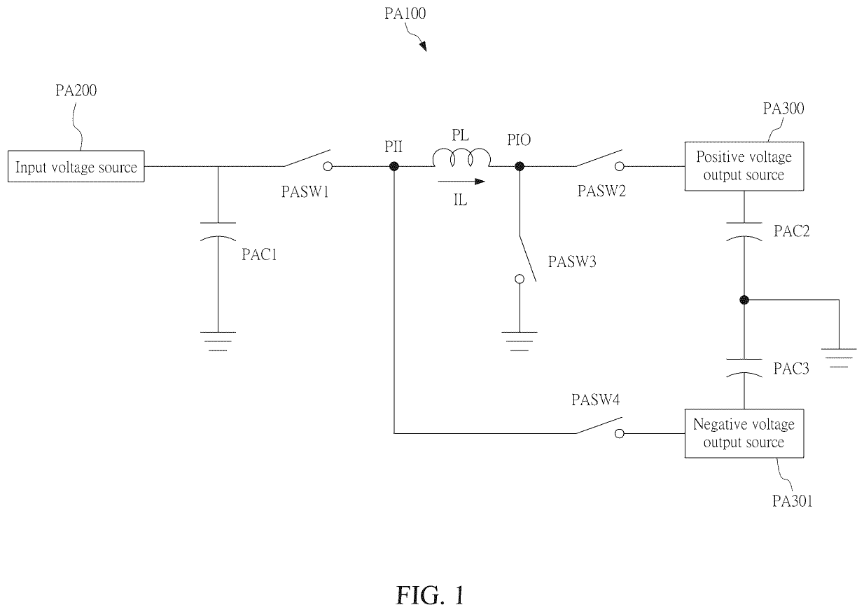

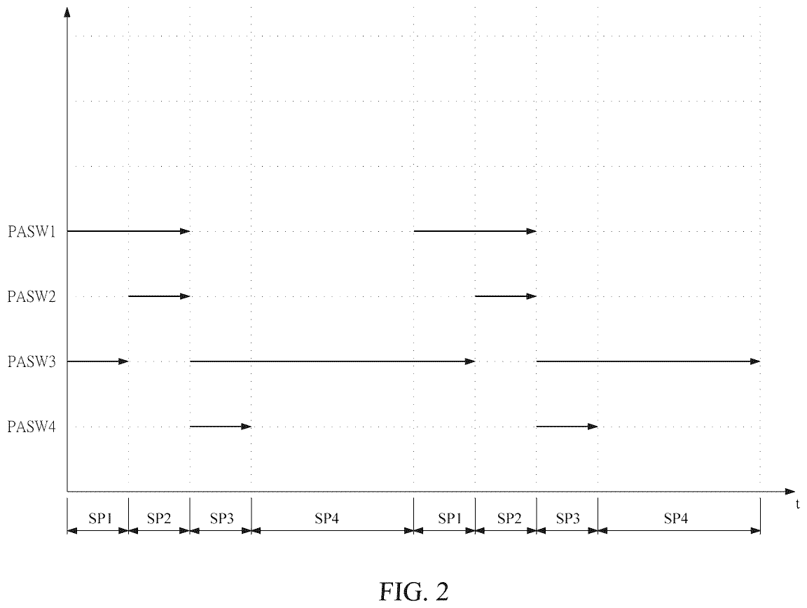

### DESCRIPTION OF THE PREFERRED EMBODIMENT

The invention disclosed herein is directed to a single-inductor multiple output converter with ringing elimination switch. In the following description, numerous details are set forth in order to provide a thorough understanding of the present invention. It will be appreciated by one skilled in the art that variations of these specific details are possible while still achieving the results of the present invention. In other instances, well-known components are not described in detail in order not to unnecessarily obscure the present invention.

Since the single-inductor multiple output converter with ringing elimination switch provided by the present invention can be widely used in various circuit structures, the details will not be described again here. Only one of the better embodiments will be specifically described for detailed description, and this embodiment is only used to conveniently and clearly assist in explaining the purpose and effect of the embodiments of the present invention.

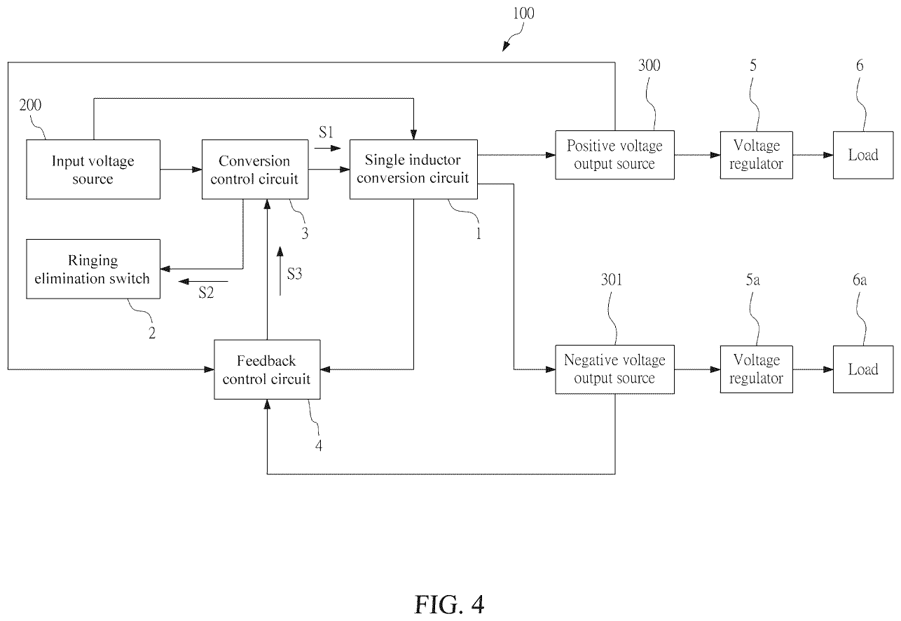

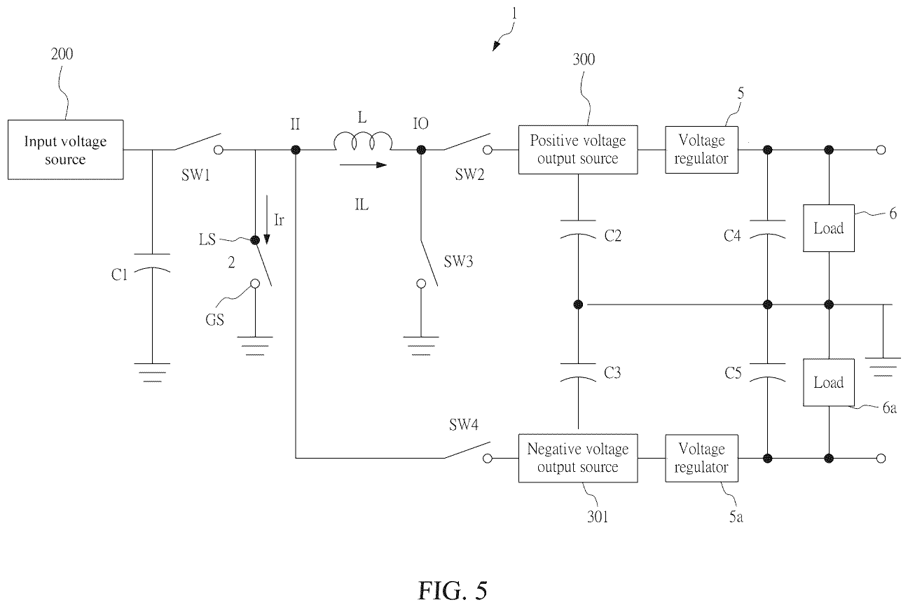

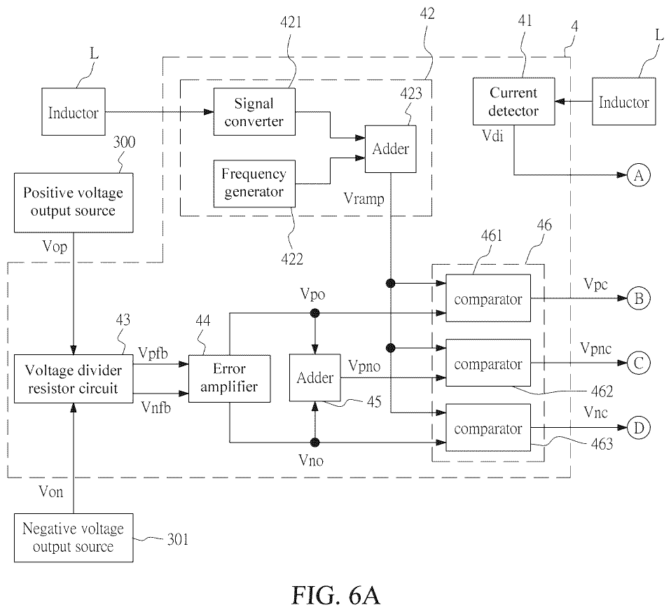

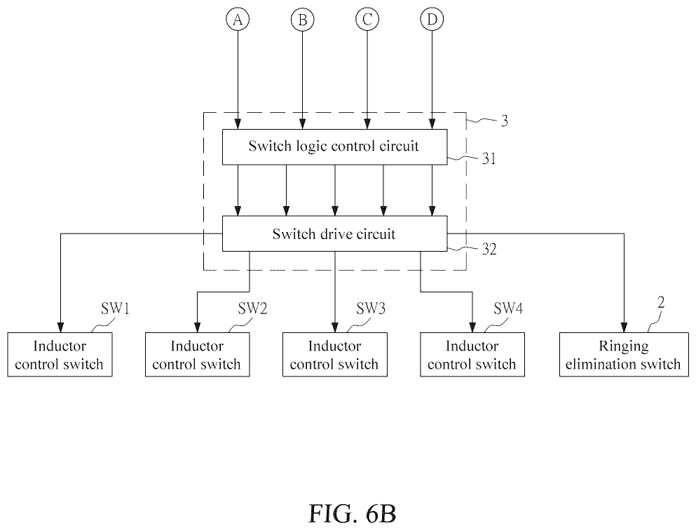

Please refer to FIGS. 4 to 6A and 6B, FIG. 4 illustrates a system block diagram of the single-inductor multiple output converter provided by the present invention, the FIG. 5 is a circuit diagram illustrating the single-inductor conversion circuit of the single-inductor multiple output converter provided by the present invention, and the FIG. 6A and FIG. 6B are circuit diagrams illustrating the conversion control circuit of the single-inductor multiple output converter provided by the present invention.

As shown in FIGS. 4 to 6A and 6B, a single-inductor multiple output converter 100 with a ringing elimination switch (hereinafter referred to as “single-inductor multiple output converter”) is used to convert the input voltage Vin of a voltage input source 200 into a plurality of output voltages and then output them to a plurality of voltage output sources respectively. In this embodiment, the output voltage includes an output positive voltage Vop and an output negative voltage Von, and are output to the positive voltage output source 300 and the negative voltage output source 301 respectively. However, in other embodiments, the output voltage may only include the output positive voltage.

In this embodiment, the single-inductor multiple output converter 100 includes a single-inductor conversion circuit 1, a ringing elimination switch 2, a conversion control circuit 3, a feedback control circuit 4, and two voltage regulators 5 and 5a and two loads 6 and 6a.

The single-inductor conversion circuit 1 is electrically connected to the voltage input source 200, the positive voltage output source 300 and the negative voltage output source 301 respectively, for converting the input voltage Vin into an output positive voltage Vop and an output negative voltage Von, and includes a Inductor L. The inductor L has a current inflow terminal II and a current outflow terminal IO, respectively has an inductor input terminal voltage LXA and an inductor output terminal voltage LXB, and during operation, an inductor current IL is generated from the current inflow terminal II to the current outflow terminal IO. The ringing elimination switch 2 is electrically connected to the single-inductor conversion circuit 1 at a connection terminal LS, and is grounded at a ground terminal GS.

The conversion control circuit 3 is electrically connected to the single-inductor conversion circuit 1 and the ringing elimination switch 2 respectively, and is used to periodically send a voltage control command S1 to the single-inductor conversion circuit 1 according to a voltage conversion sequence, and is used to send a switch turn-on control command S2 to the ringing elimination switch 2 to connect the connection terminal LS and the ground terminal GS when one of the inductors in the voltage conversion sequence interrupts the charging and discharging phases, so that a residual current Ir of the inductor L is dissipated due to grounding, thereby eliminating ringing. The relevant content of the voltage conversion sequence will be explained in the subsequent paragraphs.

The feedback control circuit 4 is electrically connected to the positive voltage output source 300, the negative voltage output source 301, the single-inductor conversion circuit 1 and the conversion control circuit 3, respectively, for sending a feedback control signal S3 to the conversion control circuit 3. The method of generating the feedback control signal S3 will be explained in the subsequent paragraphs.

The voltage regulator 5 is electrically connected to the positive voltage output source 300 and the load 6 respectively. The voltage regulator 5a is electrically connected to the negative voltage output source 301 and the load 6a respectively. In this embodiment, the voltage regulators 5 and 5a are both LDR (Low-Dropout Regulators), used to reduce the ripple generated by the single-inductor multiple output converter 100 during operation. The structure and working principle of the low dropout voltage regulator are not claimed by this invention and will not be described again in this embodiment.

In this embodiment, the single-inductor multiple output converter 100 further includes a plurality of stabilizing capacitors C1 to C5. The voltage stabilizing capacitor C1 has one end disposed adjacent to the voltage input source 200 and the other end connected to ground. The voltage stabilizing capacitor C2 has one end disposed adjacent to the positive voltage output source 300 and the other end connected to ground. The voltage stabilizing capacitor C3 has one end disposed adjacent to the negative voltage output source 301 and the other end connected to ground. The voltage stabilizing capacitor C4 has one end adjacent to the load 6 and is arranged in parallel with the load 6, and the other end is grounded. The voltage stabilizing capacitor C5 has one end adjacent to the load 6a and is arranged in parallel with the load 6a, and the other end is grounded.

In other embodiments, the single-inductor multiple output converter 100 may include different numbers of stabilizing capacitors according to actual needs, and they may be set at different positions in the converter. In the circuit structure, the voltage stabilizing capacitor is used to filter, eliminate high-frequency noise or store energy. The structure and working principle of the voltage stabilizing capacitor are not claimed by the present invention and will not be described again in this embodiment.

As shown in the FIG. 5, in this embodiment, the single-inductor conversion circuit 1 also includes a plurality of inductor control switches SW1 to SW4. The inductor control switches SW1 to SW4 are controlled on or off to repeatedly charge and discharge the inductor L, thereby converting the input voltage Vin into an output positive voltage Vop and an output negative voltage Von.

The two ends of the inductor control switch SW1 are electrically connected to the current inflow terminal II of the inductor L and the voltage input source 200 respectively. The two ends of the inductor control switch SW2 are electrically connected to the current outflow terminal IO of the inductor L and the positive voltage output source 300 respectively. One end of the inductor control switch SW3 is electrically connected to the current outflow terminal IO of the inductor L, and the other end is grounded. The two ends of the inductor control switch SW4 are electrically connected to the current inflow terminal II of the inductor L and the negative voltage output source 301 respectively.

The control sequence of the inductor control switches SW1 to SW4 will be explained in the subsequent paragraphs. In addition, in other embodiments, the single-inductor conversion circuit 1 may not include the inductor control switches SW1 to SW4, and the inductor control switches SW1 to SW4 may be replaced by other components or circuits with functions similar to the switches.

As shown in the FIG. 6a and FIG. 6b, in this embodiment, the conversion control circuit 3 includes a switch logic control circuit 31 and a switch drive circuit 32. The switch logic control circuit 31 is electrically connected to the feedback control circuit 4 and is used to generate the switch-on control command S2 and the voltage control command S1 according to the feedback control signal S3.

The switch driving circuit 32 is electrically connected to the switch logic control circuit 31, the ringing elimination switch 2 and the inductor control switches SW1 to SW4 respectively, and is used to drive the inductor control switches SW1 to SW4 to turn off or on according to the voltage control command S1, and is used to control the ringing elimination switch 2 to be turned off or on according to the switch-on control command S2.

In this embodiment, the feedback control circuit 4 includes a current detector 41, a ramp voltage generator 42, a voltage dividing resistor circuit 43, an error amplifier 44, an adder 45 and a comparator circuit 46.

The current detector 41 is electrically connected to the inductor L and the switching logic control circuit 31 respectively, and is used to generate an inductor current detector output voltage Vdi when the inductor current IL is detected to be 0.

The ramp voltage generator 42 is electrically connected to the inductor L and the comparator circuit 46 respectively, and includes a signal converter 421, a frequency generator 422 and an adder 423. In this embodiment, the ramp voltage generator 42 converts the inductor current IL into a voltage signal through the signal converter 421. Then, the adder 423 adds the voltage signal to a fixed frequency signal generated by the frequency generator 422 to generate a ramp voltage Vramp.

The voltage divider resistor circuit 43 is electrically connected to the positive voltage output source 300, the negative voltage output source 301 and the error amplifier 44 respectively, and is used to use internal resistor voltage division to convert the output positive voltage Vop and the output negative voltage Von into a positive feedback voltage Vpfb and a negative feedback voltage Vnfb respectively. The error amplifier 44 is electrically connected to the voltage divider resistor circuit 43, the adder 45 and the comparator circuit 46 respectively, and is used to convert the feedback positive voltage Vpfb into an operating positive voltage Vpo, and is used to convert the feedback negative voltage Vnfb into a calculated negative voltage Vno.

The adder 45 is electrically connected to the error amplifier 44 and the comparator circuit 46 respectively, and is used to add the positive operation voltage Vpo and the negative operation voltage Vno to obtain an operation difference voltage Vpno. The comparator circuit 46 is electrically connected to the switching logic control circuit 31, the ramp voltage generator 42, the error amplifier 44 and the adder 45 respectively, and includes three comparators 461 to 463.

The comparator 461 is used to generate a comparison positive voltage Vpc when the ramp voltage Vramp is greater than or equal to the operation positive voltage Vpo. The comparator 462 is used to generate a comparison difference voltage Vpnc when the ramp voltage Vramp is greater than or equal to the operation difference voltage Vpno. The comparator 463 is used to generate a comparative negative voltage Vnc when the ramp voltage Vramp is greater than or equal to the calculated negative voltage Vno.

To sum up, the feedback control circuit 4 generates the comparative positive voltage Vpc, the comparative difference voltage Vpnc and the comparative negative voltage Vnc by monitoring the inductor L, the positive voltage output source 300 and the negative voltage output source 301 to send the feedback control signal S3 to the switch. Logic control circuit 31. The structures and working principles of the current detector 41, the ramp voltage generator 42, the voltage divider resistor circuit 43, the error amplifier 44, the adder 45 and the comparator circuit 46 are all prior art and are not claimed by the present invention. No further details will be given in this embodiment.

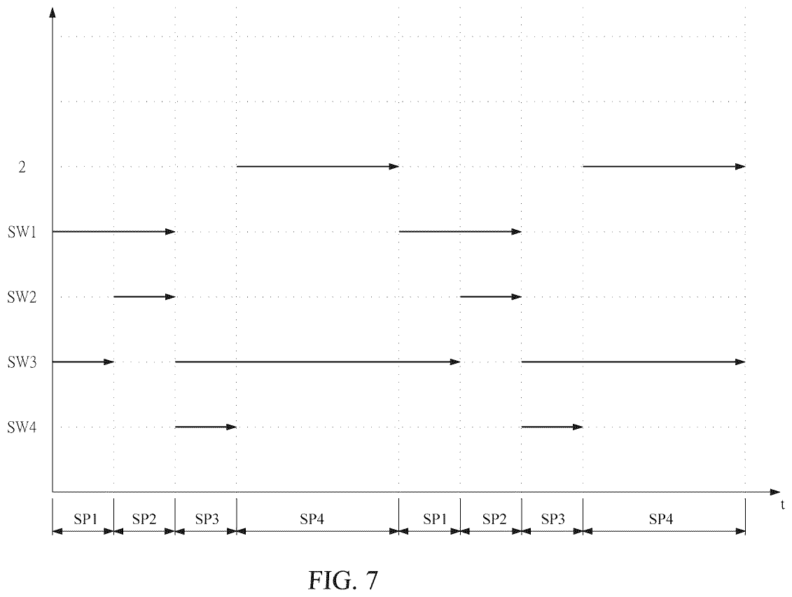

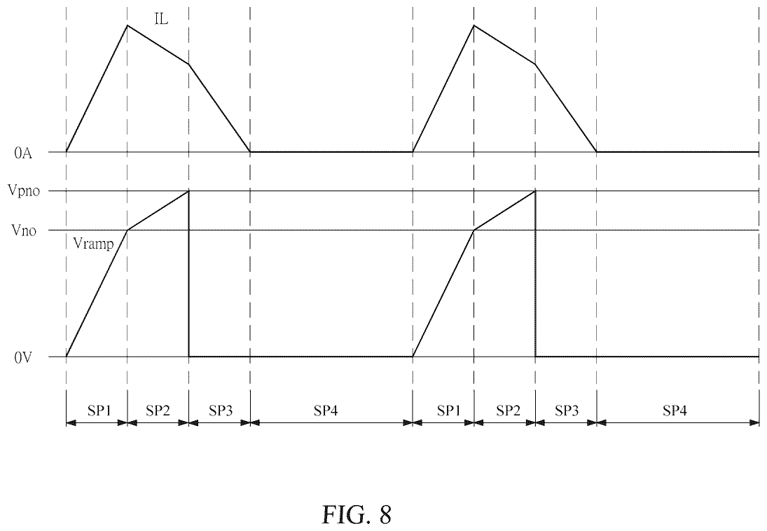

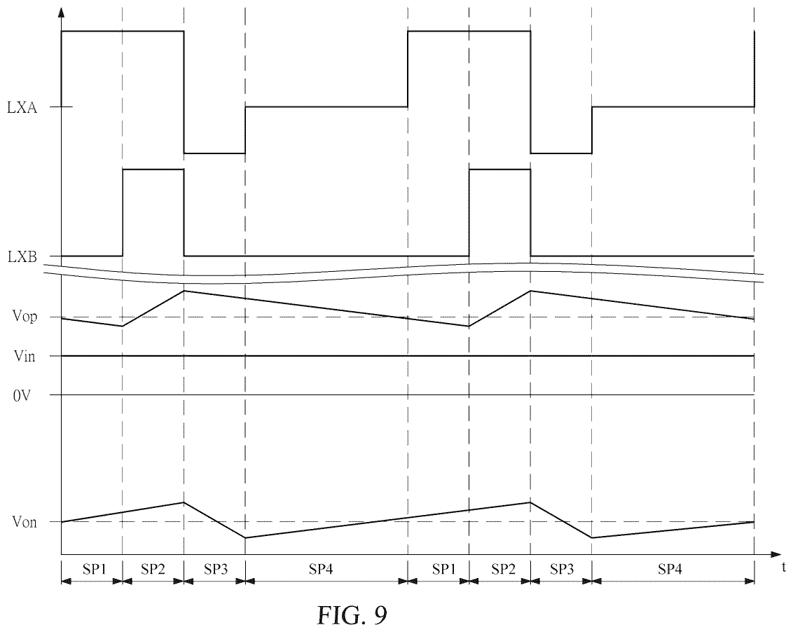

Please refer to FIGS. 7 to 9, the FIG. 7 illustrates the switching sequence diagram of the single-inductor multiple output converter provided by the present invention, the FIG. 8 illustrates the inductor current and slope voltage waveforms of the single-inductor multiple output converter provided by the present invention, and the FIG. 9 illustrates the voltage waveform diagram of the single-inductor multiple output converter provided by the present invention.

As shown in FIGS. 7 to 9, when the single-inductor multiple output converter 100 is operating, the inductor control switches SW1 to SW4 are controlled by the voltage control command S1 to turn on or off, and the ringing elimination switch 2 is turned on or off under the control of the switch-on control command S2. The voltage control command S1 includes a plurality of voltage control sub-commands arranged according to the voltage conversion sequence.

In this embodiment, a voltage conversion sequence includes four phases SP1 to SP4, and the voltage control command S1 includes a first voltage control command, a second voltage control command, a third voltage control command and a fourth voltage control command. Control commands correspond to phases SP1 to SP4 respectively.

In this embodiment, a voltage conversion sequence includes four phases SP1 to SP4, and the voltage control command S1 includes a first voltage control command, a second voltage control command, a third voltage control command and a fourth voltage control command. Control commands correspond to phases SP1 to SP4 respectively.

In the phase SP1, the first voltage control command controls the inductor control switch SW1 and the inductor control switch SW3 to be turned on. At the same time, the inductor L continues to store electric energy. When the ramp voltage Vramp continues to climb from 0 volts to the negative calculation voltage Vno, the comparison negative voltage Vnc is HIGH (the ramp voltage Vramp is greater than or equal to the negative calculation voltage Vno), and the phase SP1 ends at this point.

In phase SP2, the second voltage control command controls the inductor control switch SW3 to be turned off, the inductor control switch SW2 to be turned on, and the inductor control switch SW1 to continue to be turned on. At the same time, the output positive voltage Vop continues to rise. When the ramp voltage Vramp continues to climb to the calculated difference voltage Vpno, the comparison difference voltage Vpnc is HIGH (the ramp voltage Vramp is greater than or equal to the calculated difference voltage Vpno), and phase SP2 ends at this point.

In the phase SP3, the third voltage control command controls the inductor control switch SW1 and the inductor control switch SW2 to be turned off, and controls the inductor control switch SW3 and the inductor control switch SW4 to be turned on. At the same time, the output negative voltage Von continues to rise. When the inductor current IL gradually drops to 0, Vdi is HIGH, and phase SP3 ends at this point.

In the phase SP4, the fourth voltage control command controls the inductor control switch SW4 to turn off, and controls the inductor control switch SW3 to continue to turn on. At the same time, in the phase SP4, the switch-on control command S2 controls the ringing elimination switch 2 to be turned on, so that the residual current Ir of the inductor L is dissipated due to grounding, thereby eliminating the ringing. After repeating the above said phases SP1 to SP4, the single-inductor multiple output converter 100 can continuously convert the input voltage Vin into an output positive voltage Vop and an output negative voltage Von.

In addition, since the output positive voltage Vop and the output negative voltage Von continue to change during output and are both sawtooth wave voltages, the solid line in the FIG. 9 represents the actual voltage value, and the dotted line represents the average voltage value.

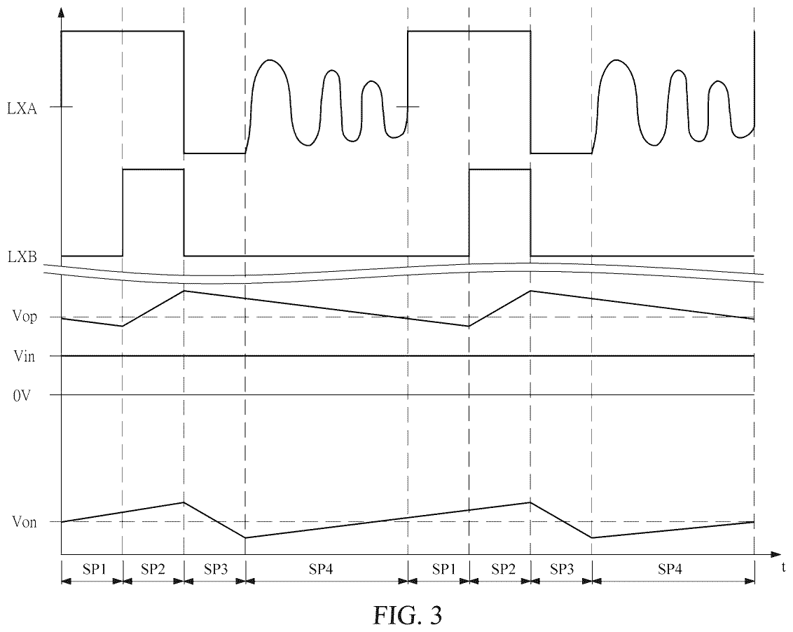

In this embodiment, different phases correspond to different inductor charging and discharging behaviors, and the phase SP4 is an inductor interruption charging and discharging phase. In other words, in the phase SP4, the inductor L does not receive current from the voltage input source 200 to charge, nor does it discharge to the positive voltage output source 300 or the negative voltage output source 301. Please refer to the FIGS. 3 and 9, compared with the FIG. 3, the inductor input terminal voltage LXA in the FIG. 9 remains stable without ringing during phase SP4.

To sum up the above, in the single-inductor multiple output converter 100 provided by the present invention, the ringing elimination switch 2 is turned on when the inductor interrupts the charging and discharging phase, so that the residual current Ir of the inductor L is dissipated due to grounding, thereby eliminating ringing and solving the above said problems.

While the present invention has been particularly shown and described with reference to a preferred embodiment, it will be understood by those skilled in the art that various changes in form and detail may be without departing from the spirit and scope of the present invention.

What is claimed is:

1. A single-inductor multiple output converter with a ringing elimination switch used to convert an input voltage of a voltage input source into a plurality of output voltages and then outputting the plurality of output voltages to a plurality of voltage output sources respectively, comprising:
a single inductor conversion circuit electrically connected to the voltage input source and the voltage output sources respectively, for converting the input voltage into the output voltages, and including an inductor;
a ringing elimination switch electrically connected to the single inductor conversion circuit at a connection terminal and grounded at a ground terminal; and
a conversion control circuit electrically connected to the single inductor conversion circuit and the ringing elimination switch respectively, for periodically sending a voltage control command to the single inductor conversion circuit according to a voltage conversion sequence, and for the situation that when an inductor in the voltage conversion sequence interrupts the charging and discharging phases, a switch-on control command is sent to the ringing elimination switch to connect the connection terminal and the grounding terminal, so that a residual current of the inductor is dissipated due to grounding, thereby eliminating ringing.

2. The single-inductor multiple output converter with a ringing elimination switch of claim 1, further comprising: a plurality of voltage regulators and a plurality of loads electrically connected to the voltage regulators, wherein the voltage regulators are electrically connected to the voltage output sources respectively to reduce ripples generated during operation.

3. The single-inductor multiple output converter with a ringing elimination switch of claim 2, wherein the voltage regulators are all LDR (Low-Dropout Regulator).

4. The single-inductor multiple output converter with a ringing elimination switch of claim 1, further comprising: a plurality of voltage stabilizing capacitors used to filter, eliminate high-frequency noise or store energy.

5. The single-inductor multiple output converter with a ringing elimination switch of claim 1, wherein the inductor has a current inflow terminal and a current outflow terminal, and during operation, an inductor current flows from the current inflow terminal to the current outflow terminal.

6. The single-inductor multiple output converter with a ringing elimination switch of claim 5, wherein the single inductor conversion circuit further includes a plurality of inductor control switches, which are controlled to be turned on or off to repeatedly charge and discharge the inductor, thereby converting the input voltage into the output voltages.

7. The single-inductor multiple output converter with a ringing elimination switch of claim 6, further comprising: a feedback control circuit electrically connected to the single inductor conversion circuit, the conversion control circuit and the voltage output sources respectively, for sending a feedback control signal to the conversion control circuit.

8. The single-inductor multiple output converter with a ringing elimination switch of claim 7, wherein the conversion control circuit comprises:
a switch logic control circuit electrically connected to the feedback control circuit and used to generate the switch on control command and the voltage control command based on the feedback control signal; and
a switch driving circuit electrically connected to the switch logic control circuit, the ringing elimination switch and the inductance control switches respectively, and used to drive the ringing elimination switch to turn off or on according to the switch on control command, and used to drive the inductor control switches to cut off or turn on according to the voltage control command.

9. The single-inductor multiple output converter with a ringing elimination switch of claim 1, wherein the voltage control command comprises a plurality of voltage control sub-commands arranged according to the voltage conversion sequence.
